(19) United States
(12) Patent Application Publication
(10) Pub. No.: US 2005/0147464 A1
(43) Pub. Date: Jul. 7, 2005

(54) Quick positioning device

(76) Inventor: Tian-Ming Lee, Daya Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/750,962

(22) Filed: Jan. 5, 2004

(51) Int. Cl. F16B 7/14

(52) U.S. Cl. 403/379.2

(57) ABSTRACT

A positioning device includes a knob having a receiving tube and a positioning tube extending from a side thereof. The positioning tube is enclosed by the receiving tube and has a first engaging portion in an inner periphery thereof. A connection member is connected to the receiving tube and a rod with a spring mounted thereto is inserted in a passage defined in the connection member. The spring is biased between the connection member and a stepped shoulder of the rod. The first end of the rod is movably inserted in the positioning tube and has a second engaging portion which is engaged with the first engaging portion. A second end of the rod extends from a distal end of the connection member. The second end of the rod is retracted in the passage by pulling the knob.

### FIELD OF THE INVENTION

The present invention relates to a quick positioning device which includes a rod movably connected to a knob and can be inserted into or disengaged from a hole in an object simply by pulling the knob.

### BACKGROUND OF THE INVENTION

A conventional quick positioning device used in exercising devices or bicycles generally includes a knob and a tube is connected to the knob, The tube includes a threaded inner periphery so as to be threadedly connected to a rod. The rod is used to be inserted in one of positioning holes defined in an object so as to position the member having the positioning device relative to the object having the positioning holes. Nevertheless, it is noted that the rod could be disengaged from the tube because of frequent vibration and the teeth of the threaded inner periphery of the tube could be broken when installing the rod in the tube. Another conventional quick positioning device includes a knob with a nut embedded therein and a rod with a threaded section is connected to the nut. The nut has to be placed in a mold of the knob and the nut is difficult to be positioned in the mold when pouring material of the knob in the mold. In addition, the rod has to be threadedly connected to the nut by rotating the rod several rounds and this takes a lot of time. The threaded engagement between the rod and the nut tends to loosen by vibration.

The present invention intends to provide a quick positioning device which is easily assembled and convenient to operate.

### SUMMARY OF THE INVENTION

The present invention relates to a positioning device which comprises a knob having a receiving tube and a positioning tube extending from a first side thereof and the positioning tube is enclosed by the receiving tube. The positioning tube has a first engaging portion in an inner periphery thereof. A connection member has a first end securely received in the receiving tube and a passage is defined in the connection member. A rod with a spring mounted thereto is inserted in the passage and a first end of the spring is stopped by a first flange extending from an inner periphery in the passage and a second end of the spring is stopped by a stepped shoulder on the rod. The first end of the rod is movably inserted in the positioning tube and has a second engaging portion which is engaged with the first engaging portion. A second end of the rod extends from a distal end of the connection member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the positioning device of the present invention;

FIG. 2 is an exploded view to show the positioning device of the present invention;

FIG. 3 is a cross sectional view of the positioning device of the present invention;

FIG. 4 shows the positioning device of the present invention is used to position an inner tube in an outer tube;

FIG. 5 shows the second end of the rod is extended through the two tubes;

FIG. 6 shows the second end of the rod is pulled out from the two tubes;

FIG. 7 shows the positioning tube includes at least one slit;

FIG. 8 shows another embodiment of the first and the second engaging portions;

FIG. 9 shows yet another embodiment of the first and the second engaging portions, and

FIG. 10 shows another embodiment of the rod.

### DETAILED DESCRIPTION OF THE PREFERRED EMBODIMENT

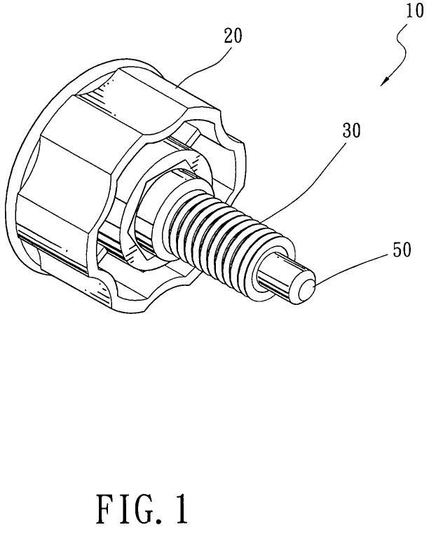

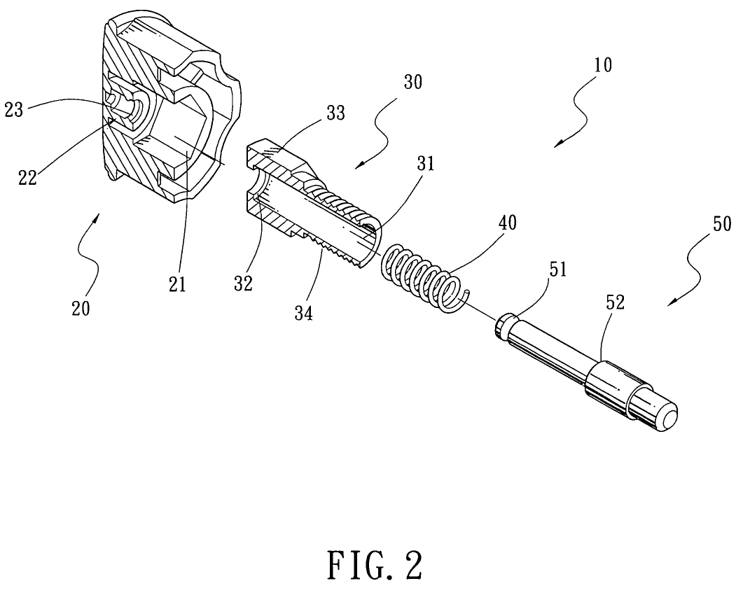

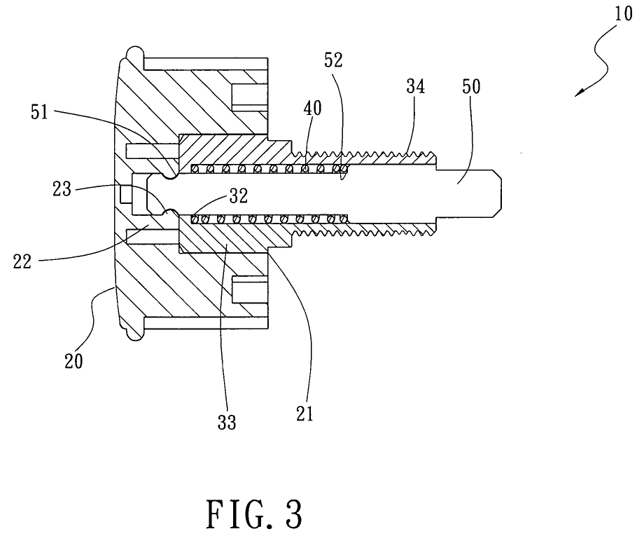

Referring to FIGS. 1 to 3, the positioning device 10 of the present invention comprises a knob 20 which has a ridge-groove outer periphery and a receiving tube 21 and a positioning tube 22 extend from a first side of the knob 20. The positioning tube 22 is located to be enclosed by the receiving tube 21 The receiving tube 22 has a polygonal inner periphery and the positioning tube 22 had a first engaging portion 23 in an inner periphery thereof. In this embodiment, the first engaging portion 23 is a flange extending inward from the inner periphery of the positioning tube 22.

A connection member 30 has a first end 33 which has a polygonal outer periphery and is engaged with the polygonal inner periphery of the receiving tube 22. A passage 31 is defined in the connection member 30 and a first flange 32 extends from an inner periphery in the passage 31. The connection member 30 further includes a section of threaded outer periphery 34. A spring 40 is received in the passage 31 and a first end of the spring 40 is stopped by the first flange 32 extending from the inner periphery in the passage 31.

A rod 50 has a second engaging portion 51 defined in an outer periphery of a first end thereof and a stepped shoulder 52 is defined in the outer periphery of the rod 50. The rod 50 inserted in the passage 31 of the receiving tube 21 and the spring 40 is mounted to the rod 50. A second end of the spring 40 is engaged with the stepped shoulder 52. The first end of the rod 50 is movably inserted in the positioning tube 22, and the first engaging portion 23 is engaged with the second engaging portion 51. In this embodiment, the second engaging portion 51 is a groove defined in the outer periphery of the rod 50. A second end of the rod 50 extends from a distal end of the connection member 30.

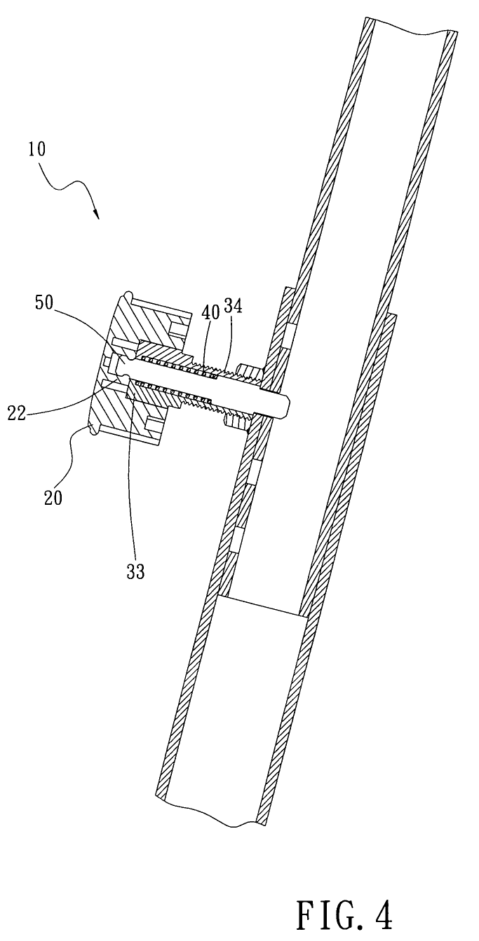

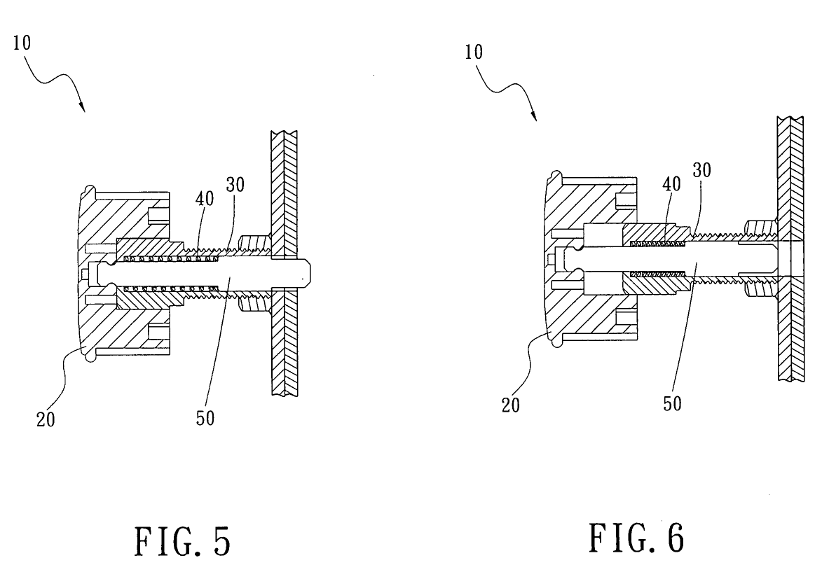

Referring to FIGS. 4 and 5, the second end of the rod 50 of the positioning device 10 is used to position an inner tube in an outer tube, wherein the section of threaded outer periphery 34 of the connection member 30 is threadedly connected to a nut on the outer tube. FIG. 6 shows that the second end of the rod 50 can be easily pulled from the aligned holes of the inner tube and the outer tube by simply pulling the knob 20 outward.

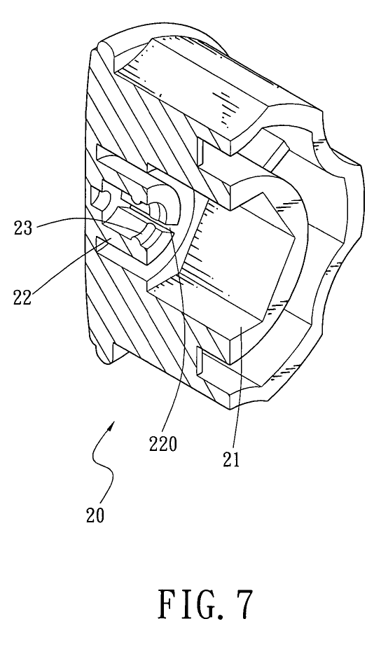

FIG. 7 shows that the positioning tube 22 may include at least one slit so as to make the positioning tube 22 to be composed of several expandable pawls to accommodate the first end of the rod 50.

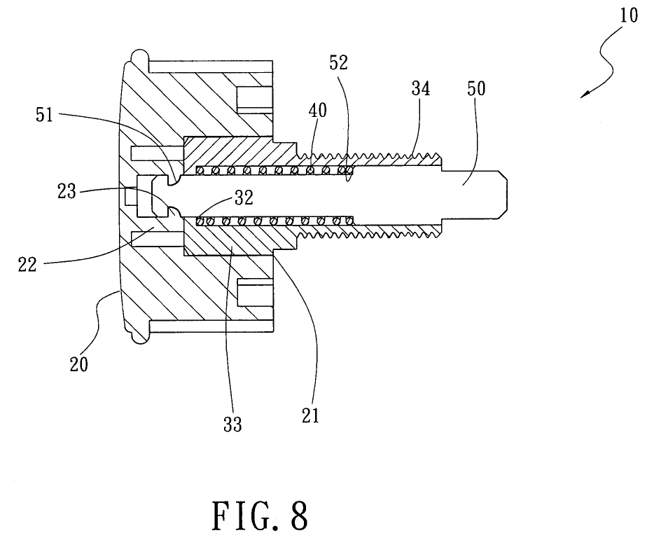

FIG. 8 shows another embodiment of the first and the second engaging portions 23, 51, wherein the first engaging portion 23 is a flange extending inward from the inner periphery of the positioning tube 22 and includes two opposite sides. One of the two opposite sides is a flat side that is perpendicular to the inner periphery of the positioning tube 22 and the other one of the two opposite sides is a curved side. The second engaging portion 51 is a groove that is shaped to compensate the first engaging portion 23.

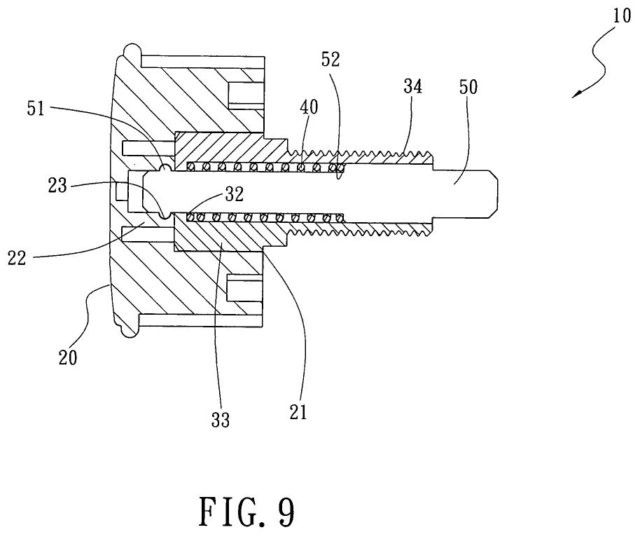

FIG. 9 shows yet another embodiment of the first and the second engaging portions 23, 51, wherein the first engaging portion 23 is a groove defined in the inner periphery of the positioning tube 22 and the second engaging portion 51 is a flange extending outward inward from the outer periphery of the rod 50.

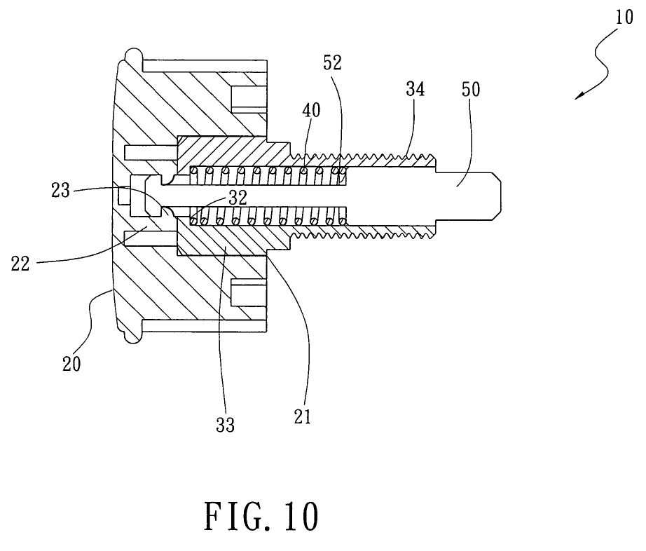

FIG. 10 shows that the first engaging portion 23 can be a flange extending inward from the inner periphery of the positioning tube 22 as that shown in FIG. 8, and the rod 50 includes a section that is sized to be inserted through a space enclosed by the flange of the first engaging portion 23. The first end of the rod 50 is an enlarged head that is stopped by the first engaging portion 23.

While we have shown and described the embodiment in accordance with the present invention, it should be clear to those skilled in the art that further embodiments may be made without departing from the scope of the present invention.

1. A positioning device comprising:
a knob (20) having a receiving tube (21) extending from a first side thereof and a positioning tube (22) extending from the first side of the knob (20) and enclosed by the receiving tube (21), the positioning tube (22) having a first engaging portion (23) in an inner periphery thereof;
a connection member (30) having a first end (33) received in the receiving tube (21) and a passage (31) defined in the connection member (30), a spring (40) received in the passage (31) and a first end of the spring (40) being stopped by a first flange (32) extending from an inner periphery in the passage (31), and
a rod (50) having a second engaging portion (51) defined in an outer periphery of a first end thereof and a stepped shoulder (52) defined in the outer periphery of the rod (50), the spring (40) mounted to the rod (50) and a second end of the spring (40) being engaged with the stepped shoulder (52), the rod (50) inserted in the passage (31) of the receiving tube (21) and the first end of the rod (50) being movably inserted in the positioning tube (22), the first engaging portion (23) being engaged with the second engaging portion (51), a second end of the rod (50) extending from a distal end of the connection member (30).

2. The device as claimed in claim 1, wherein the first engaging portion (23) is a flange extending inward from the inner periphery of the positioning tube (22) and the second engaging portion (51) is a groove defined in the outer periphery of the rod (50).

3. The device as claimed in claim 1 further comprising at least one slit (220) defined longitudinally in the positioning tube (22) so that the positioning tube (22) is composed of at least two expandable pawls.

4. The device as claimed in claim 1, wherein the first engaging portion (23) is a flange extending inward from the inner periphery of the positioning tube (22) and includes two opposite sides, one of the two opposite sides being a flat side that is perpendicular to the inner periphery of the positioning tube (22) and the other one of the two opposite sides being a curved side, the second engaging portion (51) being a groove that is shaped to compensate the first engaging portion (23).

5. The device as claimed in claim 1, wherein the first engaging portion (23) is a groove defined in the inner periphery of the positioning tube (22) and the second engaging portion (51) is a flange extending outward inward from the outer periphery of the rod (50).

6. The device as claimed in claim 1, wherein the first engaging portion (23) is a flange extending inward from the inner periphery of the positioning tube (22) and the rod (50) includes a section that is sized to be inserted through a space enclosed by the flange of the first engaging portion (23) and the first end of the rod (50) is an enlarged head that is stopped by the first engaging portion (23).

7. The device as claimed in claim 1, wherein the connection member (30) includes a section of threaded outer periphery (34).

8. The device as claimed in claim 1, wherein the receiving tube (22) has a polygonal inner periphery and the first end (33) of the connection member (30) has a polygonal outer periphery which is engaged with the polygonal inner periphery of the receiving tube (22).
